(19) United States
(12) Patent Application Publication
(10) Pub. No.: US 2025/0296483 A1
(43) Pub. Date: Sep. 25, 2025

(54) SYSTEM FOR LOCKING A CONTINUOUSLY ADJUSTABLE SLIDE

(71) Applicant: FAURECIA Sièges d'Automobile, NANTERRE (FR)

(72) Inventors: Michel TIMON, Le Vey (FR); Vincent NARDIN, Flers (FR); Olivier KIRCHER, FLERS (FR)

(21) Appl. No.: 19/082,920

(22) Filed: Mar. 18, 2025

(30) Foreign Application Priority Data
Mar. 21, 2024 (FR) 2402846

(51) Int. Cl. B60N 2/08

(52) U.S. Cl. CPC B60N 2/0825

(57) ABSTRACT

The present disclosure relates to a system for locking a continuously adjustable slide for a vehicle seat, comprising; the slide comprising a first, lower slide element configured to be fixed to a vehicle floor, and a second, upper slide element configured to slide along the first slide element, a system for locking by bracing comprising: a rail, extending lengthwise along the at least one slide, stationary relative to the first slide element, a first blocking member and a second blocking member, mounted integral with the second slide element, in positions offset along a longitudinal axis of the rail, the first blocking member configured to brace against the rail, under the action of two wedging members blocking by wedge effect in slots.

### PRIORITY CLAIM

This application claims priority to French Patent Application No. FR2402846, filed Mar. 21, 2024, which is expressly incorporated by reference herein.

### BACKGROUND

The present disclosure relates to a system for locking a slide for a continuous-adjustment vehicle seat, as well as to a vehicle seat comprising such a locking system.

### SUMMARY

According to the present disclosure, a system is proposed for locking a continuously adjustable slide for a vehicle seat, comprising:
the slide comprising a first, lower slide element, configured to be attached to a vehicle floor, and a second, upper slide element, configured to slide along the first slide element
a system for locking by bracing comprising:
   a rail, extending lengthwise along the slide, attached relative to the first slide element, the rail having a first, upper friction surface and a second, opposite, lower friction surface
   a first blocking member and a second blocking member, mounted rigidly connected to the second slide element, with positions offset along a longitudinal axis of the rail, the first blocking member comprising a first wall and a second wall, facing one another, configured to rub on the first friction surface and second friction surface of the rail, respectively, the second blocking member comprising a third wall and a fourth wall, facing one another, configured to rub on the first friction surface and second friction surface of the rail, respectively,
and wherein the first slide element is a lower profile and the second slide element is an upper profile, slidably mounted along the lower profile, the first blocking member and the second blocking member extending internally into the interspace between the upper profile and the lower profile, the rail rigidly connected to the lower profile, accommodated in the interspace and into the first blocking member and the second blocking member protrude from the upper profile through at least one opening of the upper profile.

According to the present disclosure, the system for locking by bracing comprises:
a stop means integral with the second slide element, projecting above the upper profile, the stop means interposed between, on the one hand, a projecting portion of the first blocking member extending from a first opening of the upper profile, and on the other hand, a projecting portion of the second blocking member extending from a second opening of the upper profile, and wherein the stop means comprises:
   a first stop surface facing the projecting portion of the first blocking member, defining with an opposite surface of the first blocking member a first profile slot converging along a vertical component, for example decreasing in width from bottom to top,
   a second stop surface facing the projecting portion of the second blocking member, defining with an opposite surface of the second blocking member a second slot with a profile converging along a vertical component, for example decreasing in width from bottom to top,
a first wedging element extending into the first slot and first resilient means configured to move the first wedging element along the vertical component of the first slot to a first clamping position wherein the first wedging element is blocked by wedging against the first stop surface and the projecting portion of the first blocking member by generating a first force between the first blocking member and the first wedging element providing a bracing of the first blocking member on the rail providing a locking of the second slide element relative to the first slide element in a first sliding direction, by two reactions of the rail on the first blocking member, with on the one hand a first reaction between the first upper friction surface of the rail and the first wall of the first blocking member and, on the other hand, a second reaction between the second lower friction surface of the rail and the second wall of the first blocking member,
a second wedging element extending into the second slot and second resilient means configured to move the second wedging element along the vertical component of the second slot to a second clamping position wherein the second wedging element is blocked by wedging against the second stop surface and the portion projecting from the second blocking member by generating a second force between the second blocking member and the second wedging element providing a bracing of the second blocking member on the rail providing a locking of the second slide element relative to the first slide element in a second sliding direction, by two reactions of the rail on the first blocking member, with on the one hand a third reaction between the first upper friction surface of the rail and the third wall of the second blocking member, and on the other hand a fourth reaction between the second lower friction surface of the rail and the fourth wall of the second blocking member,
an unlocking mechanism which is configured to drive the movement of the first wedging element along the vertical component of the first slot and the movement of the second wedging element along the vertical component of the second slot, from their positions constrained by the first and second resilient means providing the bracing of the first blocking member and of the second blocking member on the rail and thus the locking of the slide and to a retracted position of the first wedging element and a retracted position of the second wedging element eliminating the bracings of the first blocking member and the second member on the rail, freeing the slide so that it can slide.

The features disclosed in the following paragraphs can optionally be implemented independently of one another or in combination with one another:

According to one embodiment, the first wedging member and the second wedging member are configured to, during a longitudinal stress on the second slide element generating a micro-movement between the second slide element and the first slide element, still provide the first force and the second force providing the bracings of the first blocking member and of the second blocking member, by allowing compensations by moving one of the two wedging elements consisting of the first wedging element and the second wedging element, or even both wedging elements, by changing the point of contact between the wedging element and the blocking member consisting of the first blocking member or respectively the second blocking member, while the other wedging element, the second wedging element or respectively first wedging element, can remain immobile while retaining the contact point between the wedging element and the blocking member that is the first blocking member or respectively the second blocking member.

According to one embodiment, the slide locking system may comprise spring means between the first blocking member and the second blocking member so that the first blocking member is always in contact with the first wedging element even in the retracted position of the first wedging element releasing the sliding of the slide, and the second blocking member is always in contact with the second wedging member even in the retracted position of the second wedging member releasing the sliding of the slide.

According to one embodiment, the spring means comprise a torsion spring comprising a coil of resilient wire forming turns, the coil of resilient wire terminating with two ends bearing respectively on the first blocking member and on the second blocking member.

According to one embodiment:
the first wedging element is a first metallic wire having a wedging portion arranged in the first slot above the first opening, the first metallic wire shaped to extend below the level of the wedging portion to a hinge portion hinged to a first end of a first lever, the first lever located below the level of the first opening, the first lever having a second end hinged to a side flank of the upper profile, and wherein the first resilient means comprise a first torsion spring mounted on the second end of the first lever, configured to resiliently constrain the first lever to rotate in a direction to drive the first metallic wire up to the first constrained position of the first wedging element,
the second wedging element is a second metallic wire having a wedging portion arranged in the second slot above the second opening, the second metallic wire shaped to extend below the level of the wedging portion to a hinge portion hinged to a first end of a second lever, the second lever located below the level of the second opening, the second lever having a second end hinged to a side flank of the upper profile, and wherein the second resilient means comprise a second torsion spring mounted on the second end of the second lever, configured to resiliently constrain the second lever to rotate in a direction driving the second metallic wire upwardly to the second constrained position of the second wedging element.

According to one embodiment, the first end of the first lever and the first end of the second lever are juxtaposed, arranged along the longitudinal direction of the slide between the second end of the first lever and the second end of the second lever, the unlocking mechanism comprising a manually-operated control lever, articulated to the second slide element by a transverse shaft pivotally mounted on the side flank of the upper profile, the control lever comprising a force distribution member configured to come into contact, straddling the first lever and the second lever, configured to transmit an unlocking force to the control lever and distribute it to the first end of the first lever and to the first end of the second lever, causing the first lever to rotate about its second end against a return force of the first torsion spring and the second lever to rotate about its second end against a return force of the second spring.

According to one embodiment, the force distribution member may be wholly or partly made of an elastomer material.

According to one embodiment, the force distribution member is pivotally mounted on the control lever along a transverse hinge axis.

According to one embodiment, the wedging portion and the hinge portion of the first metallic wire or the second metallic wire extend along two parallel axes, connected by a bent portion of the wire.

According to a second aspect, the present disclosure relates to a vehicle seat comprising a squab and a backrest as well as a system for locking a continuously adjustable slide according to the present disclosure, the first slide element of which is anchored to a floor of the vehicle and the second slide element of which is rigidly connected to a frame of the squab.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 shows a vehicle seat comprising a squab and a backrest and having two locking slide locking systems, comprising two parallel slides, of which a first slide element formed by a lower profile is rigidly connected to a vehicle floor and a second slide element formed by an upper profile is rigidly connected to a frame of the seat.

FIG. 2 is a detail view of one of the two continuously adjustable slide systems of the seat of FIG. 1 comprising a first blocking member and a second blocking member configured respectively to brace on an internal rail in an interspace, the first blocking member and the second blocking member protruding through the upper profile respectively through a first opening and a second through opening.

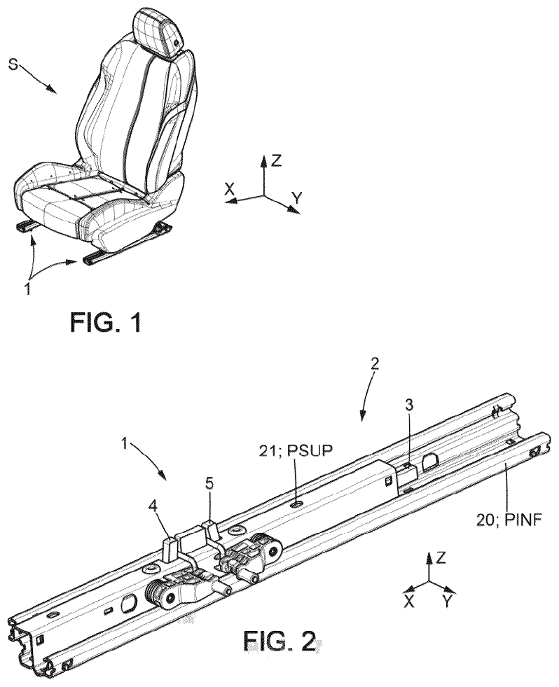

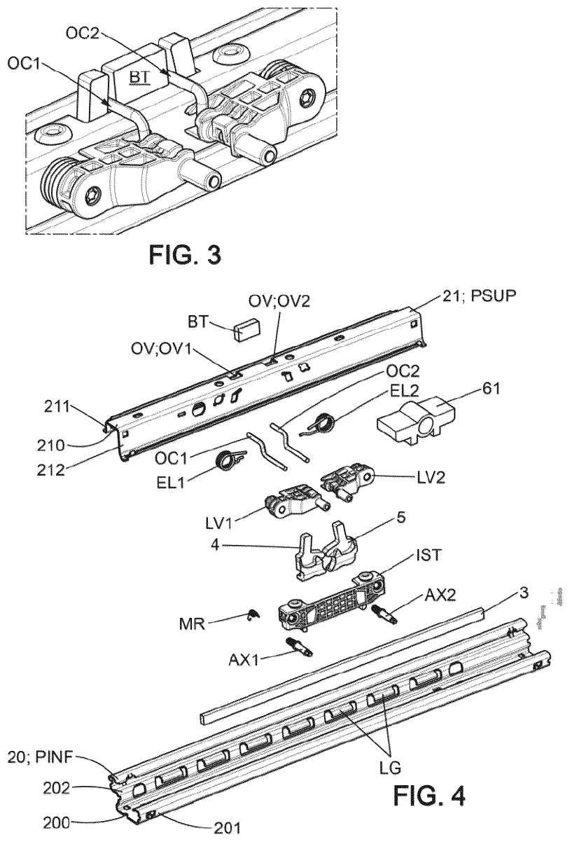

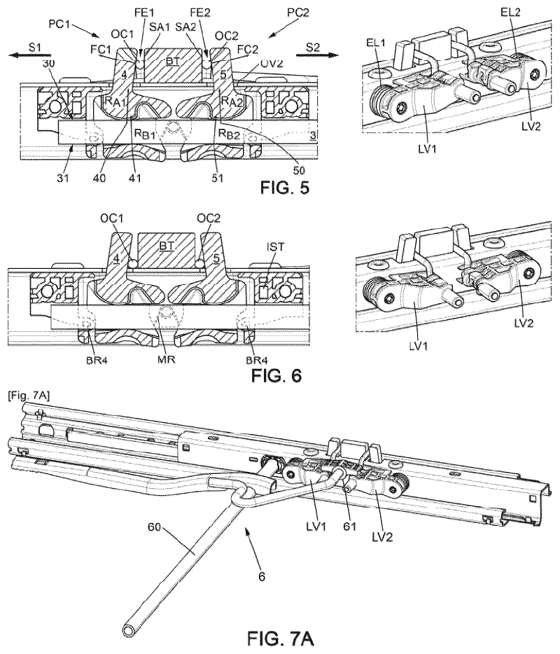

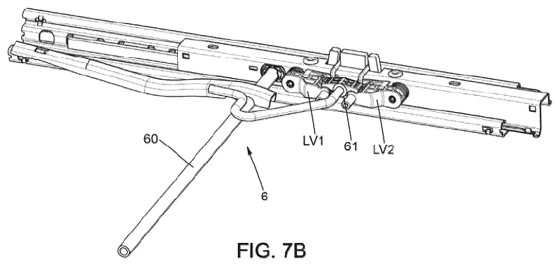

FIG. 3 is a detail view of FIG. 2, showing a stop means with a body rigidly connected to the upper slide profile, interposed, in the lengthwise direction between the first opening and the second opening, the stop means comprising:
a first vertically extending stop surface, facing a projecting portion of the first blocking member, defining, with an opposite surface of the projecting portion of the first blocking member, a first profile slot converging along a vertical component, decreasing in width from bottom to top, inside which a first wedging element is wedged to provide the bracing of the first blocking member on the rail,
a second vertically extending stop surface, facing a projecting portion of the second blocking member, defining, with an opposite surface of the projecting portion of the second blocking member, a second profile slot converging along a vertical component, decreasing in width from bottom to top, inside which a second wedging element is wedged to provide the bracing of the second blocking member on the rail.

FIG. 4 is an exploded view of the continuously adjustable slide system shown in FIG. 2.

FIG. 5 shows, on the left, a sectional view along a plane parallel to XZ, and on the right, a detailed perspective view, showing:
the first constrained position of the first wedging element clamped in the first slot by wedge effect, causing the bracing of the first locking element on the rail and the first constrained position of the first wedging element clamped in the first slot by wedge effect under the action of a first lever elastically constrained by a first torsion spring, causing the bracing of the first locking element on the rail to provide locking of the slide in a first sliding direction;
the second constrained position of the second wedging element clamped in the second slot by wedge effect under the action of a second lever elastically constrained by a second torsion spring, causing the bracing of the second locking element on the rail and the second constrained position of the second wedging element clamped in the second slot by wedge effect, causing the bracing of the second locking element on the rail to provide locking of the slide in a second sliding direction.

FIG. 6 is a view including the cross-sectional and perspective views of FIG. 5, after unlocking of the slide by elimination of the bracing conditions between the rail on the one hand, and the first and second blocking members on the other, the unlocking being achieved by rotation of the first lever about its second end against the return force of the first torsion spring, causing the first wedging member to descend into the first slot to a position eliminating the wedging, and by rotation of the second lever about its second end against the return force of the second torsion spring, causing the second wedging member to descend into the second slot to a position eliminating the wedging, the view notably showing a torsion spring integral with an insert integral with the upper profile, having a first end bearing on the first blocking member, and a second end.

FIG. 7A shows the locking system of a continuously adjustable slide in the first constrained position of the first wedging element and the second constrained position of the second wedging element, providing the locking of the slide showing in particular an unlocking mechanism comprising a control lever articulated to the upper profile along a transverse axis by a transverse shaft in an unstressed position of the unlocking mechanism.

FIG. 7B shows the locking system of a slide according to FIG. 7A, after rotation of the control lever about the transverse shaft, the unlocking mechanism comprising a force distribution member, articulated to the control lever configured to come into contact simultaneously with two facing ends belonging to the first lever and the second lever to provide simultaneous rotations of the two levers, namely the first lever and the second lever, in opposite directions of rotation, causing a downward displacement of the first wedging element in the first slot, in a widened zone of the first slot providing the elimination of the wedge effect and thus the elimination of bracing conditions between the first blocking member and the rail, as well as a downward displacement of the second wedging element in the second slot, in a widened zone of the second slot providing the elimination of the wedge effect and thus the elimination of bracing conditions between the second blocking member and the rail.

### DETAILED DESCRIPTION

Also, the present disclosure relates to a system 1 for locking a continuously adjustable slide for a vehicle seat, comprising;
the slide 2 comprising a first, lower slide element 20 configured to be fixed to a vehicle floor, and a second, upper slide element 21 configured to slide along the first slide element
a system for locking by bracing.

The system for locking by bracing allows the slide to be locked continuously in an unlimited number of locking positions over the useful stroke of the slide, as opposed to a discontinuous-adjustment system with a limited number of locking positions

The system for locking by bracing is self-sufficient in the sense that it does not complement a locking system of the discontinuous-adjustment type, with notches providing such discontinuous adjustment.

In the figures, the orthogonal reference frame XYZ is oriented so that the axis X is oriented along the sliding axis of the slide, the direction Y in the horizontal direction, transverse to the slide, perpendicular to X, and the axis Z along the vertical.

The first slide element 20 comprises a lower profile PINF, with a cross-section having a base extending substantially in a plane parallel to the XY plane, extended by one or two upward wings. The second slide element 21 comprises an upper profile PSUP, with a cross-section having a main wing 210 extending substantially in a plane parallel to the XY plane, extended by two downward wings 211, 212. The end portions of the upward wings and the end portions of the downward wings are interlocked and form raceways for rolling elements such as balls or the like.

The figures show a slide with an asymmetrical profile, that is, the vertical dimensions of the two downward (resp. upward) wings are unequal. In general, the present disclosure applies whether the profiles are asymmetrical as shown or symmetrical (not shown).

The system for locking by bracing comprises a rail 3 which extends lengthwise along the slide, fixed relative to the first slide element 20. The rail 3 is attached to the first slide element 20. To this end, the lower profile PINF forming the first slide part 20 may comprise the base and at least one upward wing extending from the base.

The rail 3 can be secured to the at least one upward wing of the lower profile PINF in the interspace between the upper profile and the lower profile, in particular by tongues LG protruding into the interspace from openings in the wall of the upward wing. The tongues may be obtained by stamping, and can be distributed along the length of the rail 3 to secure the rail. The position of the tongues relative to the blocking members enables the blocking members, that is, the first and/or second blocking member, in the unlocked state of the slide, to slide relative to the first slide element 21, by moving successively along the tongues, and without the tongues impeding the movement of the blocking members. This allows the rail to be firmly fixed along its length, including the sliding stroke of the blocking members, and not just at its ends, outside that stroke.

The rail 3 has a first, upper friction surface 30 and a second, opposite, lower friction surface 31. According to one embodiment, the first friction surface 30 and the opposite, lower, second friction surface 31 can be flat, with the rail having a substantially rectangular cross-section. However, the rail may have another cross-section, such as a circular cross-section, in which case the first surface 30 and the second surface 31 are non-planar.

The system for locking by bracing comprises a first blocking member 4 and a second blocking member 5, whose positions are offset along a longitudinal axis of the rail 3, which extends in longitudinal direction X. The first blocking member 4 and the second blocking member 5 are mounted rigidly onto the second slide element 21, that is, are movable with it, in positions offset along a longitudinal axis of the rail 3. The first blocking member 4 and the second blocking member 5 extend respectively lengthwise in a vertical direction, along the direction Z, or slightly inclined to this direction by a few degrees, with an incline of less than 25°, for example less than 10°

The first blocking member 4 comprises a first wall 40 and a second wall 41, facing each other, configured to rub against the first surface 30 and the second friction surface 31 of the rail, respectively. The first wall 40 and the second wall 41 can be formed by two opposing side walls of a groove in the first blocking member, and as shown in the figures.

The second blocking member 5 comprises a third wall 50 and a fourth wall 51, facing each other, configured to rub against the first surface 30 and the second friction surface 31 of the rail 3, respectively. The third wall 40 and the fourth wall 41 can be formed by two opposing side walls of a groove in the second blocking member 5, and as shown in the figures.

Generally speaking, the rail 3 is integral with the lower profile PINF, accommodated in the interspace, and the first blocking member 4 and the second blocking member 5 extend internally into the interspace between the upper profile PSUP and the lower profile PIN, and project from the upper profile through at least one opening OV in the upper profile PSUP. In particular, the first blocking member 4 passes through the upper profile PSUP via a first opening OV1 in the main wing, and the second blocking member 5 passes through the upper profile PSUP in particular via a second opening OV2 in the main wing, the first opening OV1 and the second opening OV2 being offset in the longitudinal direction of the slide.

The system for locking by bracing substantially comprises a stop means BT integral with the second slide element 21, projecting above the upper profile PSUP, the stop means interposed between, on the one hand, the projecting portion of the first blocking member 4 extending from the first opening OV1 of the upper profile PSUP, and on the other hand a projecting portion of the second blocking member 5 extending from the second opening OV2 of the upper profile PSUP.

The stop means BT comprises:
a first stop surface SA1 facing the protruding portion of the first blocking member 4, defining with an opposite surface of the first blocking member 4 a first slot FE1 with a profile converging along a vertical component, for example with a width decreasing from bottom to upper along the vertical direction Z, the width seen along the direction X, along the length of the slide,
a second stop surface SA2 facing the protruding portion of the second blocking member 5, defining with an opposite surface of the second blocking member, a second slot FE2 with a profile converging along a vertical component, for example of decreasing width from bottom to upper along the Z direction, the width viewed along the X direction, depending on the length of the slide.

The stop means can be formed by a one-piece body, integral with the upper profile of the slide, and as shown in the figures, and forming the first stop surface SA1 and the second stop surface SA2, by two opposite surfaces of the body, possibly parallel to one another, offset along the X direction.

Optionally, the stop means may comprise, according to an embodiment not shown, two separate or even distinct bodies respectively forming the first stop surface SA1 and the second stop surface SA2.

The system for locking by bracing further comprises a first wedging element OC1 extending into the first slot FE1 and first elastic means EL1 configured to constrain the first wedging element OC1 to displacement along the vertical component of the first slot FE1 up to a first constrained clamping position PC1 (shown as an example in FIG. 5) wherein the first wedging element OC1 wedges against the first stop surface SA1 and the projecting portion of the first blocking member 4.

The first clamping position PC1 generates a first force FC1 between the first blocking member 4 and the first wedging element OC1 providing a bracing of the first blocking member 4 on the rail 3 providing a locking of the second slide element 21 relative to the first slide element 20 in a first sliding direction S1, by two reactions of the rail on the first blocking member, with on the one hand a first reaction R_{A1} between the first upper friction surface 30 of the rail and the first wall 40 of the first blocking member 4 and, on the other hand, a second reaction R_{B1} between the second lower friction surface 31 of the rail and the second wall 41 of the first blocking member 4.

The system for locking by bracing further comprises a second wedging element OC2 extending into the second slot FE2 and second elastic means EL2 configured to constrain the second wedging element OC2 to displacement along the vertical component of the second slot FE2 to a second constrained clamping position PC2 wherein the second wedging element OC2 wedges against the second stop surface SA2 and the projecting portion of the second blocking member 5.

The second constrained position PC2 generates a second force FC2 between the second blocking member 5 and the wedging element OC2, providing a bracing of the second blocking member 5 on the rail 3 providing a locking of the second slide element 21 relative to the first slide element in a second sliding direction S2, by two reactions of the rail on the first blocking member, with on the one hand a third reaction R_{A2} between the first upper friction surface 30 of the rail and the third wall 50 of the second blocking member and, on the other hand, a fourth reaction R_{B2} between the second lower friction surface 31 of the rail and the fourth wall 51 of the second blocking member 5.

The locking system also comprises an unlocking mechanism 6 that is configured to drive the movement of the first wedging element OC1 along the vertical component of the first slot FE1 and the movement of the second wedging element OC2 along the component of the second slot FE2 from their positions PC1, PC2 constrained by the first and second resilient means EL1, EL2 providing the bracing of the first blocking member and of the second blocking member on the rail, and thus the locking of the slide and to a retracted position of the first wedging element OC1 and a retracted position of the second wedging element OC2 eliminating the bracings of the first blocking member 4 and the second member 5 on the rail 3, releasing the slide so that it may slide.

The passage from the first constrained position PC1 of the first wedging member OC1 to the retracted position is achieved by moving the first wedging member OC1 along the first stop surface SA1 along the vertical component of the first slot FE1, and for example from upper to bottom according to an embodiment particularly shown in the figures.

The passage of the second wedging member OC2 from the second constrained position PC2 to the retracted position is achieved by moving the second wedging member OC2 along the second stop surface SA2 along the vertical component of the slot, and for example from upper to bottom according to an embodiment shown in the figures.

According to one embodiment:
the first wedging member OC1 comprises a wedging portion extending in the transverse direction Y along the depth of the first slot FE1, which may be circular in cross-section when viewed in the XZ plane,
the second wedging member OC2 comprises a wedging portion extending in the transverse direction Y along the depth of the second slot FE2, which may be circular in cross-section when viewed in the XZ plane,

The diameter of the circular cross-section of the wedging portion (of the first wedging member OC1 and/or of the second wedging member OC2) can advantageously be small, for example between 3 mm and 6 mm.

Such construction makes it possible to reduce the overall dimensions of the assembly of first blocking member 4, second blocking member 5, stop means BT, first and second wedging members OC1, OC2, when viewed in the X direction, longitudinal to the slide.

Preferably, the first wedging member OC1 and the second wedging member OC2 are independent, configured, during a longitudinal stress on the second slide element 21 generating a micro-movement between the second slide element 21 and the first slide element 20, to still provide the first force FC1 and the second force FC2 providing the bracings of the first blocking member 4 and of the second blocking member 5, by allowing compensations by moving one of the wedging elements consisting of the first wedging element OC1 and the second wedging element OC2, or even both of the wedging elements, by changing the point of contact between the wedging element and the blocking member consisting of the first blocking member 4 or respectively the second blocking member 5, while the other wedging element, the second wedging element OC2 or respectively first wedging element (OC1), can remain immobile while retaining the contact point between the wedging element and the blocking member consisting of the first blocking member or respectively the second blocking member.

In other words, the first wedging element OC1 and second wedging element OC2 can perform, independently of one another, respectively a first compensation on the first blocking member 4 and/or a second compensation on the second blocking member 5 as a function of the longitudinal stresses and in particular of their direction.

The continuously adjustable slide locking system may comprise spring means MR between the first blocking member 4 and the second blocking member 5, the spring means configured so that the first blocking member 4 is always in contact with first wedging element OC1 even in the retracted position of first wedging element C01 releasing the sliding of the slide, and that the second blocking member 5 is always in contact with the second wedging member CO2 even in the retracted position of the second wedging member C02 releasing the sliding of the slide.

Under the effect of the spring means MR, the first wedging member OC1 is also in contact with the first stop surface SA1, and the second wedging member OC2 is in contact with the second stop surface SA2, in the retracted positions of the members OC1, OC2.

According to one embodiment, the spring means MR comprise a torsion spring comprising a coil of resilient wire forming turns, the coil of resilient wire terminating with two ends bearing respectively on the first blocking member 4 and on the second blocking member 5.

As shown in FIG. 6, the torsion spring can force the first blocking member 4 and the second blocking member 5 respectively to tilt in opposite directions, so as to always provide contact of the first wedging member OC1 with the first blocking member 4, as well as with the first stop surface SA1, and always provide contact of the second wedging member OC2 with the second blocking member 5, as well as with the second stop surface SA2.

Generally speaking, a support, fore example, plastic, forms an insert IST accommodated in the interspace between the upper profile PSUP and the lower profile PINF. The insert IST is slidably connected to the upper section PSUP, attached in particular to the main, upper wall of the upper profile 21. The insert support comprises a cavity opening out in the transverse direction, receiving the inner portions of the first blocking element 4 and the second blocking element 5.

Note that the torsion spring can be attached to the insert, between the two blocking members 4, 5, with the coil winding mounted on a pin projecting from the insert in the transverse direction Y.

Generally speaking, the insert may comprise a first reference stop BR4 configured to engage the first blocking member 5 to block it in the longitudinal direction X, and a second reference stop BR5 configured to engage the second blocking member 5 to block it in the longitudinal direction X. The first reference stop BR4 and the second reference stop BR5 are directed towards one another, and configured to maintain a maximum gap between the two blocking members 4, 5.

According to one embodiment (shown in the figures) the first wedging element OC1 can be a first metal wire, for example, of circular cross-section, comprising the wedging portion arranged in the first slot FE1 above the first opening OV1, the first metal wire shaped to extend in particular along a transverse component Y, and along a vertical component Z, below the level of the wedging portion as far as a hinge portion of the metal wire hinged to a first end of a first lever LV1.

The first lever LV1 is located below the level of the first opening OV1, the first lever LV1 having a second end hinged to a side flank of the upper profile PSUP, in particular and wherein the first elastic means EL1 comprise a first torsion spring mounted on the second end of the first lever, configured to elastically constrain the first lever LV1 in rotation in a direction driving the first wire upwards to the first constrained position of the first wedging element.

The first lever LV1 is hinged to the hinge portion of the metallic wire along a pivot axis, extending along the transverse direction Y. To this end, the first end of the first lever LV1 comprises a first hole inside which the hinge portion of the metallic wire is free to pivot.

The first lever LV1 is articulated to the side of the upper profile along a pivot axis extending in the transverse direction Y. To this end, a first pin AX1 is attached to the upper profile of the slide, and the second end of the lever comprises a second hole inside which the first pin is free to pivot.

The first pin AX1 can, for example, pass through a hole in the descending wing 212 of the upper profile and be attached in a mounting hole in the insert IST.

The second wedging element OC2 may be a second metallic wire having a wedging portion arranged in the second slot FE2 above the second opening OV2, the second metallic wire shaped to extend below the level of the wedging portion to an articulation portion hinged to a first end of a second lever LV2.

The second lever LV2 is located below the level of the second opening OV2, the second lever LV2 having a second end articulated to a side flank of the upper profile PSUP. The second elastic means EL2 comprise a second torsion spring mounted on the second end of the second lever LV2, configured to elastically constrain the second lever LV2 in rotation in a direction driving the second metallic wire upwards to the second constrained position of the second wedging element OC2.

The second lever LV2 is hinged to the wire hinge portion along a pivot axis, extending in the transverse direction Y. To this end, the first end of the second lever LV2 comprises a first hole inside which the metallic wire hinge portion is free to pivot.

The second lever LV2 is articulated to the side of the upper profile along a pivot axis extending in the transverse direction Y. To this end, a second pin AX2 is attached to the upper profile of the slide, and the second end of the lever comprises a second hole inside which the first pin is free to pivot.

The second pin AX2 can, for example, pass through a hole in the descending wing 212 of the upper section and be fixed in a mounting hole in the insert IST.

The wedging portion and the hinge portion of the first metallic wire (or of the second metallic wire) can extend along two parallel axes, connected to one another by a bent portion of the metallic wire.

Note that the first end of the first lever LVI and the first end of the second lever LV2 can be juxtaposed, arranged in the longitudinal direction of the slide between the second end of the first lever LVI and the second end of the second lever LV2.

The unlocking mechanism 6 may comprise a control lever, for example, manually operated, for example accessible by the seat occupant, below a front portion of the squab.

The control lever can be hinged to the second slide element 21 by a transverse shaft 60 pivotally mounted on the side flank of the upper profile PSUP, in particular pivotally mounted on a bearing integral with a descending wing 212 of the upper profile.

The control lever comprises a force distribution member 61 configured to come into contact, straddling the first lever LV1 and the second lever LV2. The force distribution member is configured to transmit a control lever releasing force and to distribute it to the first end of the first lever LV1 and to the first end of the second lever L2, causing the first lever LV1 to rotate about its second end against a return force of the first torsion spring and the second lever LV2 to rotate about its second end against a return force of the second spring, until the first blocking member 4 and the second blocking member 5 are unblocked.

The effect distribution member 61 may be wholly or partly made of an elastomer material, at least in a zone of contact with the levers LV1, LV2.

An arrangement of this kind, comprising metallic wires configured to act as wedging members OC1, OC2 and resiliently-stressed levers (first lever LV1, second lever LV2), makes it possible to limit the system's overall dimensions in the vertical direction Z, and in particular its overall dimensions above the upper profile, in that the levers (first and second lever) are offset below the main wing 210 of the upper profile 210, located in a lateral zone of the profile that is not very intrusive when integrated with a seat.

Such an arrangement facilitates the integration of such a slide system with a seat, in particular its attachment with the seat frame, in that the volume of the locking system located above the main wing 210 of the upper section is reduced, and in comparison with a design as taught by WO2023242497.

The present disclosure further relates to a vehicle seat comprising a squab and a backrest as well as a locking system of a continuously-adjustable slide according to the present disclosure, the first slide element 20 of which is anchored to a floor of the vehicle and the second slide element 21 of which is rigidly connected to a frame of the squab.

The seat may feature two continuously adjustable slide locking systems, with two parallel slides. In this case, the control lever can be shared by the two slides, with cross shaft 60 articulated to the upper profiles of both slides.

The present disclosure relates to the field of systems for adjusting and locking a slide for a motor vehicle. It relates more particularly to adjustment systems whose slides connect a squab of the seat to the floor of the vehicle.

In the present disclosure, a vehicle seat may comprise:
a squab, which extends in a direction X, from a front edge and to a rear edge, and extends transversely in a direction Y, from a first lateral edge to a second lateral edge,
a backrest that extends heightwise from the rear edge of the squab, in a direction Z, vertical or inclined towards the rear, from a lower edge to an upper edge of the backrest, and extends transversely in a direction Y, from a first lateral edge, to a second lateral edge.

The backrest may be tiltable relative to the squa by a pivot axis between the backrest frame and the squab frame, extending along the transverse direction Y.

The position of the seat in the vehicle may be adjusted, along the direction X, by means of an adjustment and locking system according to the present disclosure, or even preferably two adjustment and locking systems, with two slides connecting the squab to the floor of the vehicle.

Thus, the or each of the two slides comprises two slide elements with a first slide element rigidly connected to the floor, for example, a lower profile, and a second slide element rigidly connected to the squab of the seat, for example, an upper profile, the two slide elements being configured to slide relative to one another in the direction X.

The adjustment and locking system further comprises a locking system, including a control member which is commanded, for example, manually or in a motorized fashion, to unlock the slide in order to allow the occupant of the seat to adjust the position of the seat by moving the first slide element, which is movable relative to the second slide element.

Once the position of the seat has been adjusted, the control member is released to lock the seat in adjustment positions corresponding to adjustment steps of the slide.

To this end, there are comparative locking systems with discontinuous adjustment that have a locking system comprising a support, rigidly connected to the second slide element, and blocking members, movable relative to the support, configured to penetrate adjustment openings integral with the first slide element in a locked state of the locking system, under the action of resilient means such as springs. The control member, when it is actuated, makes it possible to force the blocking members against the force of the springs and thus to extract the blocking members from the adjustment openings, freeing the slide so that it can slide.

A first comparative locking system family is designated “step lock” by the person skilled in the art, for which the blocking members, for example, rigidly connected to one another, provide the blocking of the slide only if the relative position between the two slide elements, the first slide element and second slide element, corresponds to an adjustment step of the slide.

A second comparative family of locking system with improved safety relative to the first family, usually designated “instant lock” by the person skilled in the art, which again provides a blocking of the two elements of the slide, and even if the position between the two slide elements, the first slide element and second slide element, is in any intermediate position between two consecutive adjustment positions.

To this end, the blocking members are independent of one another and are configured so that at least one of the members penetrates and becomes immobilized in one of the adjustment openings, which are, for example, oblong in shape, even if the slide is in this any intermediate position between two adjustment steps, namely two consecutive adjustment positions of the slide.

The slide can then no longer slide over a stroke corresponding to the adjustment step of the slide. A slight sliding of the first slide element relative to the second slide element enables the other blocking members that are not penetrating to face the adjustment openings and be locked therein when the slide is moved in either of the two consecutive adjustment positions, in order to achieve the locking of the slide. In both cases, whether it is a locking system of the step lock type or the instant lock type, the number of adjustment positions is limited to the number of locking positions permitted by the system's adjustment step.

The present disclosure however relates to the locking slide system with continuous adjustment, namely one that affords an unlimited number of adjustment positions over the length of the slide, and as opposed to the adjustment and locking system described above, with discontinuous adjustment.

Comparative continuous adjustment locking systems for a motor vehicle may comprise a rail, rigidly connected to a first fixed part of the slide, rigidly connected to a floor of the vehicle and a blocking member pair, including a first blocking member and a second blocking member rigidly connected to a second movable part of the slide rigidly connected to the squab frame of the seat.

In a first relative position between the first blocking member and the second blocking member, corresponding to the unlocking of the system, the first and second locking member are configured to move freely along the rail, without blocking, allowing the slide to freely slide.

In a second relative position between the first blocking member and the second blocking member, they begin to brace against the rail under the following bracing conditions, generating:
a first force generated by a first abutment of the second slide part on the first blocking member providing an over-center of the first locking member on the rail providing a blocking of the second slide clement relative to the first slide element in a first sliding direction, by two reactions of the rail on the first blocking member, with on the one hand a first reaction between a first upper friction surface of the rail and a first wall of the first friction member and, on the other hand, a second reaction between a second lower friction surface of the rail and a second wall of the first blocking member,
a second force generated by a second abutment on the second blocking member providing an over-center of the second blocking member on the rail providing a locking of the second slide element relative to the first slide element in a second sliding direction, by two reactions of the rail on the second blocking member, with on the one hand a third reaction between a first upper friction surface of the rail and the third wall of the second friction member and, on the other hand, a fourth reaction between the second lower friction surface of the rail and the fourth wall of the second blocking member.

For these comparative devices, there may be problems with micro-movements of the slide, caused by stresses on the seat, and therefore on the movable part of the slide, in particular stresses in alternate directions, which can occur as a result of successive accelerations and decelerations of the vehicle.

According to the inventors' findings, in particular when a unidirectional stress is applied to the second movable part of the slide, a very small movement is generated between the second movable part and the first fixed part of the slide, thereby strengthening the force of one of the abutments, that is, the first abutment or respectively the second abutment, depending on the direction of displacement, and cause the loss of the other abutment, that is, the second abutment (or respectively the first abutment), by breaking the bracing conditions for the blocking member that lost the abutment, that is, the first blocking member or respectively the second blocking member.

As a result of the blocking member having lost the abutment, the static equilibrium of the blocking member is no longer provided, and the locking member shifts by a few hundredths of a millimeter until it reaches an uncertain static equilibrium position. According to the inventors' findings, such a phenomenon can lead to micro-movements, as and when longitudinal stresses in alternating directions occur, and such as may be encountered in a vehicle during successive accelerations and decelerations of the vehicle.

Furthermore, in such a comparative device, the slide is unlocked by tilting the two blocking members from the second position to the first position, with loss of the abutments, that is, first and second abutment. As the slide is locked and then unlocked, the first and second abutments are successively lost each time the slide is unlocked, and then regained each time it is locked, which can lead to a loss of reference between the blocking members and the second slide element/rail, and over time to unsatisfactory over-center conditions as a result of these dispersions.

Another comparative locking system for a continuously adjustable slide which comprises:
the slide comprising a first, lower slide element, configured to be attached to a vehicle floor, and a second, upper slide element, configured to slide along the first slide element
a system for locking by bracing comprising:—a rail, extending lengthwise along the slide, attached relative to the first slide element, the rail having a first, upper friction surface and a second, opposite, lower friction surface
a first blocking member and a second blocking member, mounted rigidly connected to the second slide element, with positions offset along a longitudinal axis of the rail, the first blocking member comprising a first wall and a second wall, facing one another, configured to rub on the first friction surface and second friction surface of the rail, respectively, the second blocking member comprising a third wall and a fourth wall, facing one another, configured to rub on the first friction surface and second friction surface, respectively, of the rail.

Notably, the system for locking by bracing further comprises:
a first cam, rigidly connected to the second slide element, and first resilient means configured to move the first cam to provide contact with the first locking member by generating a first force between the first blocking member and the first cam providing an over-center of the first blocking member on the rail providing a blocking of the second slide element relative to the first slide element in a first sliding direction, by two reactions of the rail on the first blocking member, with on the one hand a first reaction between the first upper friction surface of the rail and the first wall of the first blocking member and, on the other hand, a second reaction between the second lower friction surface of the rail and the second wall of the first blocking member,
a second cam, rigidly connected to the second slide element, and second resilient means configured to move the second cam to provide contact with the first blocking member by generating a second force between the second blocking member and the second cam providing a bracing of the second blocking member on the rail providing a locking of the second slide element relative to the first slide element (20) in a second sliding direction, by two reactions of the rail on the second blocking member, with on the one hand a third reaction between the first upper friction surface of the rail and the third wall of the second blocking member and, on the other hand, a fourth reaction between the second lower friction surface of the rail and the fourth wall of the second blocking member.

In the bracing condition, the first cam and second cam can respond to the problems of micro-movements in that they operate, independently of one another, respectively a first compensation on the first blocking member and/or a second compensation on the second blocking member as a function of the longitudinal stresses and in particular of their direction.

The locking system further comprises an unlocking mechanism which is configured to drive the movement of the first cam and the movement of the second cam from their positions constrained by the first and second resilient means providing the bracing of the first blocking member and of the second blocking member on the rail and thus the locking of the slide, and to a retracted position of the first cam and a retracted position of the second cam eliminating the bracings of the first blocking member and the second member on the rail, freeing the slide so that it can slide.

An advantageous comparative locking system comprises first spring means between the second slide element and the first blocking member so that the first blocking member is always in contact with the cam element even in the retracted position of the first cam releasing the sliding of the slide, and second spring means between the second slide element and the second blocking member so that the second blocking member is always in contact with the second cam even in the retracted position of the second cam releasing the sliding of the slide.

Conventionally:
the X direction extends along the length of the slide, for example, horizontally
the Y direction extends in a direction perpendicular to the horizontal X direction
the Z direction extends in vertical direction.

A first comparative embodiment wherein the first cam and the second cam are each articulated along a horizontal pivot axis, for example, in the Y direction

A second comparative embodiment wherein the first cam and the second cam are articulated along a vertical pivot axis, that is, along the Z direction, providing a gain in terms of vertical compactness.

According to the inventors' findings, while the comparative locking system for a continuously adjustable vehicle seat slide is advantageous in that it makes it possible to respond to the aforementioned problems of micro-movements, or even of bearing points, it can still be improved with regard to compactness, and in particular compactness in the Z direction and/or in the X direction, in particular with regard to the part of the system for locking by bracing extending above the second slide element, for example, the male profile

The present disclosure improves the situation over comparative systems.

A system is proposed for locking a continuously adjustable slide for a vehicle seat, comprising:
the slide comprising a first, lower slide element, configured to be attached to a vehicle floor, and a second, upper slide element, configured to slide along the first slide element
   a system for locking by bracing comprising:
   a rail, extending lengthwise along the slide, attached relative to the first slide element, the rail having a first, upper friction surface and a second, opposite, lower friction surface
   a first blocking member and a second blocking member, mounted rigidly connected to the second slide element, with positions offset along a longitudinal axis of the rail, the first blocking member comprising a first wall and a second wall, facing one another, configured to rub on the first friction surface and second friction surface of the rail, respectively, the second blocking member comprising a third wall and a fourth wall, facing one another, configured to rub on the first friction surface and second friction surface of the rail, respectively,
and wherein the first slide element is a lower profile and the second slide element is an upper profile, slidably mounted along the lower profile, the first blocking member and the second blocking member extending internally into the interspace between the upper profile and the lower profile, the rail rigidly connected to the lower profile, accommodated in the interspace and into the first blocking member and the second blocking member protrude from the upper profile through at least one opening of the upper profile.

According to the present disclosure, the system for locking by bracing comprises:
a stop means integral with the second slide element, projecting above the upper profile, the stop means interposed between, on the one hand, a projecting portion of the first blocking member extending from a first opening of the upper profile, and on the other hand, a projecting portion of the second blocking member extending from a second opening of the upper profile, and wherein the stop means comprises:
   a first stop surface facing the projecting portion of the first blocking member, defining with an opposite surface of the first blocking member a first profile slot converging along a vertical component, for example decreasing in width from bottom to top,
   a second stop surface facing the projecting portion of the second blocking member, defining with an opposite surface of the second blocking member a second slot with a profile converging along a vertical component, for example decreasing in width from bottom to top,
a first wedging element extending into the first slot and first resilient means configured to move the first wedging element along the vertical component of the first slot to a first clamping position wherein the first wedging element is blocked by wedging against the first stop surface and the projecting portion of the first blocking member by generating a first force between the first blocking member and the first wedging element providing a bracing of the first blocking member on the rail providing a locking of the second slide element relative to the first slide element in a first sliding direction, by two reactions of the rail on the first blocking member, with on the one hand a first reaction between the first upper friction surface of the rail and the first wall of the first blocking member and, on the other hand, a second reaction between the second lower friction surface of the rail and the second wall of the first blocking member,
a second wedging element extending into the second slot and second resilient means configured to move the second wedging element along the vertical component of the second slot to a second clamping position wherein the second wedging element is blocked by wedging against the second stop surface and the portion projecting from the second blocking member by generating a second force between the second blocking member and the second wedging element providing a bracing of the second blocking member on the rail providing a locking of the second slide element relative to the first slide element in a second sliding direction, by two reactions of the rail on the first blocking member, with on the one hand a third reaction between the first upper friction surface of the rail and the third wall of the second blocking member, and on the other hand a fourth reaction between the second lower friction surface of the rail and the fourth wall of the second blocking member,
an unlocking mechanism which is configured to drive the movement of the first wedging element along the vertical component of the first slot and the movement of the second wedging element along the vertical component of the second slot, from their positions constrained by the first and second resilient means providing the bracing of the first blocking member and of the second blocking member on the rail and thus the locking of the slide and to a retracted position of the first wedging element and a retracted position of the second wedging element eliminating the bracings of the first blocking member and the second member on the rail, freeing the slide so that it can slide.

The features disclosed in the following paragraphs can optionally be implemented independently of one another or in combination with one another:

According to one embodiment, the first wedging member and the second wedging member are configured to, during a longitudinal stress on the second slide element generating a micro-movement between the second slide element and the first slide element, still provide the first force and the second force providing the bracings of the first blocking member and of the second blocking member, by allowing compensations by moving one of the two wedging elements consisting of the first wedging element and the second wedging element, or even both wedging elements, by changing the point of contact between the wedging element and the blocking member consisting of the first blocking member or respectively the second blocking member, while the other wedging element, the second wedging element or respectively first wedging element, can remain immobile while retaining the contact point between the wedging element and the blocking member that is the first blocking member or respectively the second blocking member.

According to one embodiment, the slide locking system may comprise spring means between the first blocking member and the second blocking member so that the first blocking member is always in contact with the first wedging element even in the retracted position of the first wedging element releasing the sliding of the slide, and the second blocking member is always in contact with the second wedging member even in the retracted position of the second wedging member releasing the sliding of the slide.

According to one embodiment, the spring means comprise a torsion spring comprising a coil of resilient wire forming turns, the coil of resilient wire terminating with two ends bearing respectively on the first blocking member and on the second blocking member.

According to one embodiment:
the first wedging element is a first metallic wire having a wedging portion arranged in the first slot above the first opening, the first metallic wire shaped to extend below the level of the wedging portion to a hinge portion hinged to a first end of a first lever, the first lever located below the level of the first opening, the first lever having a second end hinged to a side flank of the upper profile, and wherein the first resilient means comprise a first torsion spring mounted on the second end of the first lever, configured to resiliently constrain the first lever to rotate in a direction to drive the first metallic wire up to the first constrained position of the first wedging element,
the second wedging element is a second metallic wire having a wedging portion arranged in the second slot above the second opening, the second metallic wire shaped to extend below the level of the wedging portion to a hinge portion hinged to a first end of a second lever, the second lever located below the level of the second opening, the second lever having a second end hinged to a side flank of the upper profile, and wherein the second resilient means comprise a second torsion spring mounted on the second end of the second lever, configured to resiliently constrain the second lever to rotate in a direction driving the second metallic wire upwardly to the second constrained position of the second wedging element.

According to one embodiment, the first end of the first lever and the first end of the second lever are juxtaposed, arranged along the longitudinal direction of the slide between the second end of the first lever and the second end of the second lever, the unlocking mechanism comprising a manually-operated control lever, articulated to the second slide element by a transverse shaft pivotally mounted on the side flank of the upper profile, the control lever comprising a force distribution member configured to come into contact, straddling the first lever and the second lever, configured to transmit an unlocking force to the control lever and distribute it to the first end of the first lever and to the first end of the second lever, causing the first lever to rotate about its second end against a return force of the first torsion spring and the second lever to rotate about its second end against a return force of the second spring.

According to one embodiment, the force distribution member may be wholly or partly made of an elastomer material.

According to one embodiment, the force distribution member is pivotally mounted on the control lever along a transverse hinge axis.

According to one embodiment, the wedging portion and the hinge portion of the first metallic wire or the second metallic wire extend along two parallel axes, connected by a bent portion of the wire.

According to a second aspect, the present disclosure relates to a vehicle seat comprising a squab and a backrest as well as a system for locking a continuously adjustable slide according to the present disclosure, the first slide element of which is anchored to a floor of the vehicle and the second slide element of which is rigidly connected to a frame of the squab.

The present disclosure relates to a system (1) for locking a continuously adjustable slide for a vehicle seat, comprising;
the slide (2) comprising a first, lower slide element (20) configured to be fixed to a vehicle floor, and a second, upper slide element (21) configured to slide along the first slide element
a system for locking by bracing comprising:
   a rail (3), extending lengthwise along the at least one slide, stationary relative to the first slide element
   a first blocking member (4) and a second blocking member (5), mounted integral with the second slide element (21), in positions offset along a longitudinal axis of the rail (3), the first blocking member (4) configured to brace against the rail, under the action of two wedging members (OC1, OC2) blocking by wedge effect in slots (FE1, FE2).

The following list of element numbers may be used in the application:
1: A system for locking a continuous-adjustment vehicle slide,
2. Slide
20. First slide element,
200. Base,
201, 202. Upward wings,
LG. Tongues
PINF. Lower profile,
Second slide element,
210. Main wing,
211, 212. Downward wings
PSUP. Upper profile
3. Rail,
30. First friction surface,
31. Second friction surface,
4. First blocking member,
40, 41. Respectively first wall and second wall (configured to over-center on the rail),
5. Second blocking member,
50, 51. Respectively third wall and fourth wall (configured to over-center on the rail),
BT. Stop means,
BR4, BR5. First and second reference stops
EL1, EL2. First and second resilient means,
OC1. First wedging element,
OC2. Second wedging element,
FE1. First slot,
FE2. Second slot,
S1. First direction,
S2. Second direction

1. A system for locking a continuously adjustable slide for a vehicle seat, comprising;
the slide comprising a first, lower slide element configured to be attached to a vehicle floor, and a second, upper slide element configured to slide along the first slide element
a system for locking by bracing, comprising:
a rail, extending lengthwise along the slide, fixed relative to the first slide element, the rail having a first, upper friction surface and a second, opposite, lower friction surface,
a first blocking member and a second blocking member, mounted rigidly connected to the second slide element, with positions offset along a longitudinal axis of the rail, the first blocking member comprising a first wall and a second wall, facing one another, configured to rub on the first friction surface and second friction surface of the rail, respectively, the second blocking member comprising a third wall and a fourth wall, facing one another, configured to rub on the first friction surface and second friction surface, respectively, of the rail,
and wherein the first slide element is a lower profile and the second slide element is an upper profile, slidably mounted along the lower profile, the first blocking member and the second blocking member extending internally into an interspace between the upper profile and the lower profile, the rail rigidly connected to the lower profile, accommodated in the interspace and in the first blocking member and the second blocking member protrude from the upper profile through at least one opening of the upper profile,
wherein the system for locking by bracing comprises:
a stop means integral with the second slide element, extending above the upper profile, the stop means interposed between, on the one hand, a protruding portion of the first blocking member extending from a first opening of the upper profile, and on the other hand a protruding portion of the second blocking member extending from a second opening of the upper profile, and wherein the stop means comprising:
a first stop surface facing the projecting portion of the first blocking member, defining with an opposite surface of the first blocking member a first slot with a profile converging along a vertical component, for example decreasing in width from bottom to top,
a second stop surface facing the protruding portion of the second blocking member, defining with an opposite surface of the second blocking member a second slot with a profile converging along a vertical component, for example decreasing in width from bottom to top,
a first wedging element extending in the first slot and first resilient means configured to move the first wedging element along the vertical component of the first slot to a first clamping position wherein the first wedging element is blocked by wedging effect against the first stop surface and the portion protruding from the first blocking member by generating a first force between the first blocking member and the first wedging element providing a bracing of the first blocking member on the rail providing a locking of the second slide element relative to the first slide element in a first sliding direction, by two reactions of the rail on the first blocking member, with on the one hand a first reaction between the first upper friction surface of the rail and the first wall of the first blocking member and, on the other hand, a second reaction between the second lower friction surface of the rail and the second wall of the first blocking member,
a second wedging element extending into the second slot and second resilient means configured to move the second wedging element along the vertical component of the second slot to a second clamping position wherein the second wedging element is blocked by wedging against the second stop surface and the portion projecting from the second blocking member, generating a second force between the second blocking member and the second wedging element providing a bracing of the second blocking member on the rail, locking the second slide element relative to the first slide element in a second sliding direction, by two reactions of the rail on the first blocking member, with, on the one hand, a third reaction between the first upper friction surface of the rail and the third wall of the second blocking member and, on the other hand, a fourth reaction between the second lower friction surface of the rail and the fourth wall of the second blocking member,
an unlocking mechanism which is configured to drive the movement of the first wedging element along the vertical component of the first slot and the movement of the second wedging element along the vertical component of the second slot, from their positions constrained by the first and second resilient means providing the bracings of the first blocking member and of the second blocking member on the rail and thus the locking of the slide and to a retracted position of the first wedging element and a retracted position of the second wedging element eliminating the bracings of the first blocking member and the second member on the rail, freeing the slide so that it may slide.

2. The system of claim 1, wherein the first wedging member and the second wedging member are configured to, during a longitudinal stress on the second slide element generating a micro-movement between the second slide element and the first slide element, still provide the first force and the second force providing the bracings of the first blocking member and of the second blocking member, by allowing compensations by moving one of the wedging elements consisting of the first wedging element and the second wedging element, or even both wedging elements, by changing the point of contact between the wedging element and the blocking member that is the first blocking member or respectively the second blocking member, while the other wedging element, the second wedging element or respectively first wedging element, can remain immobile while retaining the contact point between the wedging element and the blocking member that is the first blocking member or respectively the second blocking member.

3. The system of claim 1, further comprising spring means between the first blocking member and the second blocking member so that the first blocking member is always in contact with the first wedging element even in the retracted position of the first wedging element releasing the sliding of the slide, and that the second blocking member is always in contact with the second wedging member even in the retracted position of the second wedging member releasing the sliding of the slide.

4. The system of claim 3, wherein the spring means comprises a torsion spring comprising a coil of an resilient wire forming turns, the coil of resilient wire terminating in two ends bearing respectively on the first blocking member and on the second blocking member.

5. The system of claim 1, wherein:
the first wedging element is a first metallic wire having a wedging portion arranged in the first slot above the first opening, the first metallic wire shaped to extend below the level of the wedging portion to a hinge portion hinged to a first end of a first lever, the first lever located below the level of the first opening, the first lever having a second end hinged to a side flank of the upper profile, and wherein the first resilient means comprise a first torsion spring mounted on the second end of the first lever, configured to resiliently constrain the first lever in rotation in a direction driving the first metallic wire up to the first constrained position of the first wedging element,
the second wedging element is a second metallic wire having a wedging portion arranged in the second slot above the second opening, the second metallic wire shaped to extend below the level of the wedging portion to a hinge portion hinged to a first end of a second lever, the second lever located below the level of the second opening, the second lever having a second end hinged to a side flank of the upper profile, and wherein the second resilient means comprise a second torsion spring mounted on the second end of the second lever, configured to resiliently constrain the second lever in rotation in a direction driving the second metallic wire upwards to the second constrained position of the second wedging element.

6. The system of claim 5, wherein the first end of the first lever and the first end of the second lever are juxtaposed, arranged in the longitudinal direction of the slide between the second end of the first lever and the second end of the second lever, the unlocking mechanism comprising a manually-operated control lever articulated to the second slide element by a transverse shaft pivotally mounted on the side flank of the upper profile, the control lever comprising a force distribution member configured to come into contact, straddling the first lever and the second lever, configured to transmit an unlocking force to the control lever and distribute it to the first end of the first lever and to the first end of the second lever, causing the first lever to rotate about its second end against a return force of the first torsion spring and the second lever to rotate about its second end against a return force of the second spring.

7. The system of claim 6, wherein the force distribution member is wholly or partly made of an elastomeric material.

8. The system of claim 6, wherein the force distribution member is pivotally mounted on the control lever along a transverse hinge axis.

9. The system of claim 5, wherein the wedging portion and the hinge portion of the first metallic wire or of the second metallic wire extend along two parallel axes, connected to one another by a bent portion of the metallic wire.

10. The system of claim 1, wherein the first wedging member and the second wedging member are configured to, during a longitudinal stress on the second slide element generating a micro-movement between the second slide element and the first slide element, still provide the first force and the second force providing the bracings of the first blocking member and of the second blocking member, by allowing compensations by moving one of the wedging elements comprising the first wedging element and the second wedging element, or even both wedging elements, by changing the point of contact between the wedging element and the blocking member that is the first blocking member or respectively the second blocking member, while the other wedging element, the second wedging element or respectively first wedging element, can remain immobile while retaining the contact point between the wedging element and the blocking member that is the first blocking member or respectively the second blocking member.

11. A vehicle seat comprising a squab and a backrest as well as the system of claim 1, the first slide element of which is anchored to a floor of the vehicle and the second slide element of which is rigidly connected to a frame of the squab.
